(19) United States
(12) Patent Application Publication
(10) Pub. No.: US 2004/0190653 A1
(43) Pub. Date: Sep. 30, 2004

(54) Reception apparatus for receiving time-division signal

(75) Inventors: Ikuo Yasui, Hyogo (JP); Hisayasu Sato, Hyogo (JP)

Correspondence Address: McDermott, Will & Emery, 600 13th Street, N.W., Washington, DC, 20005-3096, US

(73) Assignee: RENESAS TECHNOLOGY CORP.

(21) Appl. No.: 10/665,468

(22) Filed: Sep. 22, 2003

(30) Foreign Application Priority Data
Mar. 28, 2003 (JP) 2003-090077 (P)

(51) Int. Cl. H04L 27/08

(52) U.S. Cl. 375/345

(57) ABSTRACT

An initial value register stores gain control amount initial value at the start of a reception frame. At the start of reception frame, a latch unit outputs the value of the gain control amount initial value that has been taken in from initial value register and latched at the end of previous reception frame as a gain control value. A variable gain amplifier amplifies a signal received from mixer in accordance with this initial value. Thereafter, the gain of variable gain amplifier is controlled by a feedback loop structured with an RSSI circuit, a gain control circuit, and a D/A converter circuit, such that the signal level of a reception signal is stabilized at a prescribed level.

### BACKGROUND OF THE INVENTION

1. Field of the Invention

The present invention relates to a reception apparatus, and specifically, to a reception apparatus for receiving a time-division signal (a signal divided into time slots) and controlling the gain thereof.

2. Description of the Background Art

A time division duplex (hereinafter also referred to as “TDD”) scheme employed for PHS (Personal Handyphone System) and the like is generally known as one of duplexing modes in digital radio communication. In the TDD system, the transmission and the reception of a signal are divided into time slots and duplexed to carry out both of the transmission and the reception at the same frequency. Though the requirement for the stability of frequency is not strict and the advantage of reducing the number of transmitters of a base station is attained in the TDD system, fast-speed processing is necessary and reduction of the power consumption associated therewith is the problem to be addressed.

Accordingly, in the TDD system a scheme for reducing the power consumption is generally known, where the power of reception circuitry is turned off when a signal is transmitted (hereinafter, the time slot in which a signal is transmitted is also referred to as “transmission frame”) and the power of transmission circuitry is turned off when a signal is received (hereinafter, the time slot in which a signal is received is also referred to as “reception frame”).

The signal received by a reception apparatus including the above mentioned reception circuitry is usually associated with a level fluctuation due to the distance from a transmission apparatus, the effect of the environment, fading and the like. Generally, for receiving such a signal with level fluctuation, the reception apparatus is provided with an automatic gain control apparatus (hereinafter also referred to as “AGC”) for controlling the gain of the reception signal.

The fast-speed processing is required for the above mentioned TDD system, and as for AGC, it is specifically required to have a high-speed gain controllability at the start of a reception frame.

As such, a method for improving the gain controllability of AGC at the start of a reception frame is disclosed in Japanese Patent Laying Open No. 2000-165272, where, in a TDMA (Time Division Multiple Access) system or a TDD system including reception circuitry with AGC, the power supply of circuitry not affecting the gain controllability of AGC is turned on/off synchronizing to transmission and reception of a signal in order to reduce the power consumption. Further, as a gain control voltage that determines the gain of AGC, a gain control voltage at the previous reception frame is employed.

In AGC of TDD system, if the gain control amount is reset for each reception frame and the gain control is started from 0, it will take much time until the gain is stabilized and thus the gain controllability is degraded. Here, the scheme disclosed in the above mentioned Japanese Patent Laying Open No. 2000-165272 uses the gain of the previous reception frame in order to improving the gain controllability of AGC. However, when the environment changes during a transmission frame (the period not receiving a signal), the gain controllability of AGC at the start of a reception frame is significantly degraded.

Then, for improving the responsivity of AGC, it may be contemplated to set high responsivity for the gain control of AGC. However, simply setting high responsivity for the gain control of AGC, the power consumption is increased. Further, it may require additional circuitry, which in turn may increase the circuitry area.

If the gain of AGC can be determined at an early stage, not only the reception characteristics are improved but also the power consumed for the gain control is reduced by the shortened control time. Hence, it contributes to the reduction of power consumption as well.

### SUMMARY OF THE INVENTION

Accordingly, the present invention is directed to solve the problems above, and an object thereof is to provide a reception apparatus that has great gain controllability of AGC at the start of a reception frame while reducing the power consumption.

According to the present invention, a reception apparatus is for receiving a time-division signal, and includes a variable gain amplifier circuit amplifying the signal received at an antenna to change a level of the signal to a prescribed level; a gain control circuit outputting a gain control amount to the variable gain amplifier circuit to control a gain of the signal in the variable gain amplifier circuit; and a register storing an initial value of the gain control amount that is set from outside. The gain control circuit starts to control the gain at each reception frame, using the initial value stored in the register.

Therefore, according to the present invention, the initial value of gain control amount may be set externally, and a register is provided that is capable of storing that initial value, which is used for the gain control of the reception signal in a reception frame. Thus, even when the environment changes in a period except for a reception frame, an improved gain controllability can be attained immediately after the start of the reception frame.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an overall block diagram schematically showing a radio apparatus to which a reception apparatus according to the present invention is mounted;

FIG. 2 is a functional block diagram functionally illustrating a reception apparatus according to a first embodiment of the present invention;

FIG. 3 is an operational waveform diagram of main signals in the reception apparatus according to the first embodiment;

FIG. 4 is a functional block diagram functionally illustrating a reception apparatus according to a second embodiment of the present invention;

FIG. 5 is an operational waveform diagram of main signals in the reception apparatus according to the second embodiment;

FIG. 6 is a functional block diagram functionally illustrating a reception apparatus according to a third embodiment of the present invention;

FIG. 7 is an operational waveform diagram of main signals in the reception apparatus according to the third embodiment;

FIG. 8 is a functional block diagram functionally illustrating a reception apparatus according to a fourth embodiment of the present invention;

FIG. 9 is a functional block diagram functionally illustrating a reception apparatus according to a fifth embodiment of the present invention; and

FIG. 10 is a functional block diagram functionally illustrating a reception apparatus according to a sixth embodiment of the present invention.

### DESCRIPTION OF THE PREFERRED EMBODIMENTS

In the following, referring to the figures, embodiments of the present invention will be described in detail. Throughout the figures, the same or corresponding parts are given the same reference character, and the description thereof is not repeated.

First Embodiment

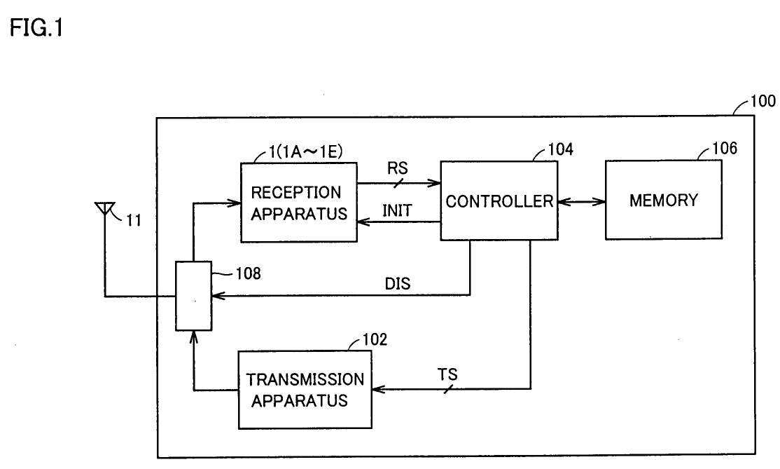

FIG. 1 is an overall block diagram schematically showing a radio apparatus to which a reception apparatus according to the present invention is mounted.

Referring to FIG. 1, a radio apparatus 100 includes a reception apparatus 1, a transmission apparatus 102, a controller 104, a memory 106, and a transmission/reception divider 108. This radio apparatus 100 is configured with an integrated circuit, where circuitry constituting these parts is provided on one semiconductor chip.

This radio apparatus 100 performs a signal transmission and reception in accordance with the above described TDD scheme. In a reception frame for receiving a signal, reception apparatus 1 receives a signal from antenna 11 via transmission/reception divider 108, amplifies thus received signal to a prescribed signal level by AGC provided inside, and outputs it to controller 104 as a reception signal RS. Additionally, reception apparatus 1 receives gain control amount initial value INIT for controlling the gain of the reception signal by AGC from controller 104 at a prescribed timing, and stores thus received initial value in an initial value register provided inside. Here, the prescribed timing refers to a time point where the power supply of radio apparatus 100 is turned on, or when radio apparatus 100 is reset. The initial value register will be described in detail later.

Controller 104 controls the operation of each apparatus in radio apparatus 100. In a reception frame, controller 104 receives reception signal RS from reception apparatus 1, and stores thus received reception signal RS in memory 106. Additionally, controller 104 outputs gain control amount initial value INIT or a control signal such as a reception period signal, which is not shown, to reception apparatus 1.

In a transmission frame for transmitting a signal, the power supply of reception apparatus 1 except for a prescribed circuitry is turned off in accordance with a control signal received from controller 104. The configuration and operation of reception apparatus 1 will be described in detail later.

Controller 104 reads a signal from memory 106 in a transmission frame, and outputs thus read transmission signal TS to transmission apparatus 102. Additionally, controller 104 outputs a control signal such as a transmission period signal to a transmission apparatus 102, for indicating that it is in a transmission frame.

Memory 106 includes a volatile memory and a non-volatile memory (not shown). The volatile memory stores reception signal RS and the like. The non-volatile memory stores the above described gain control amount initial value INIT that is designed in advance.

Transmission apparatus 102 receives transmission signal TS from controller 104, and amplifies the signal level of that transmission signal TS and outputs it to transmission/reception divider 108. The power supply of transmission apparatus 102 is turned off in reception frame in accordance with a control signal received from controller 104.

Transmission/reception divider 108, in response to divide signal DIS received from controller 104, connects either one of reception apparatus 1 or transmission apparatus 102 to antenna 11, and disconnects the other. Divide signal DIS synchronizes with the above described reception period signal and transmission period signal.

As above, in radio apparatus 100, during a reception frame, reception apparatus 1 performs the reception operation of a signal connected to antenna 11 via transmission/reception divider 108, while the power supply of transmission apparatus 102 is turned off. During a transmission frame, transmission apparatus 102 performs transmission operation connected to antenna 11 via transmission/reception divider 108, while the power supply of reception apparatus 1 is turned off except for prescribed circuitry. By alternating the transmission frame and the reception frame at a prescribed interval, radio apparatus 100 transmits and receives a signal in one frequency band.

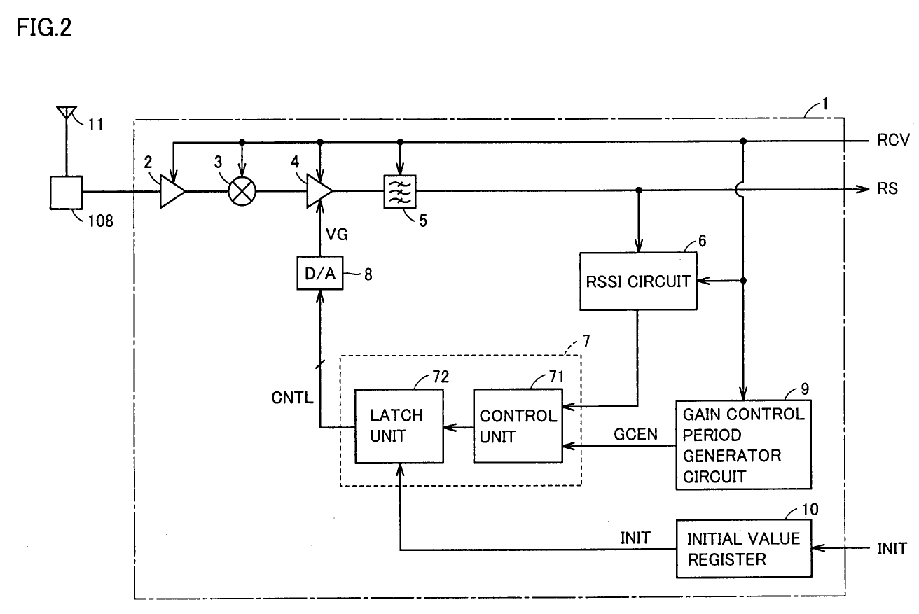

FIG. 2 is a functional block diagram functionally illustrating the reception apparatus according to the first embodiment of the present invention.

Referring to FIG. 2, reception apparatus 1 includes a low noise amplifier (hereinafter also referred to as “LNA”) 2, a mixer 3, a variable gain amplifier 4, a filter 5, an RSSI (Received Signal Strength Indicator) circuit 6, a gain control circuit 7, a digital/analog (D/A) converter circuit 8, a gain control period generator circuit 9, and an initial value register 10. Gain control circuit 7 includes a control unit 71 and a latch unit 72.

LNA 2 receives a radio signal divided into time slots and received at antenna 11 via transmission/reception divider 108, then amplifies thus received signal with low noise and outputs it to mixer 3. Mixer 3 mixes the signal received from LNA 2 with a local oscillator signal received from a local oscillator circuit, which is not shown, to convert it to a signal of a prescribed frequency band. Variable gain amplifier 4 amplifies the level of a signal received from a mixer 3 in accordance with a gain control voltage VG received from D/A converter circuit 8. Filter 5 removes an image signal from the signal amplified by variable gain amplifier 4, and outputs reception signal RS to controller 104 (not shown) shown in FIG. 1 and RSSI circuit 6. RSSI circuit 6 detects a signal level of reception signal RS and outputs a level detect signal corresponding to thus detected signal level to gain control circuit 7.

Control unit 71 of gain control circuit 7 determines a gain control amount in variable gain amplifier 4 in accordance with the level detect signal received from RSSI circuit 6, and outputs thus determined gain control amount to latch unit 72. Here, control unit 71 receives a gain control period signal GCEN from gain control period generator circuit 9, and outputs thus determined gain control amount to latch unit 72 when gain control period signal GCEN is at H (logic high) level. On the other hand, control unit 71 does not output the gain control amount to latch unit 72 when gain control period signal GCEN is at L (logic low) level. Gain control period signal GCEN will be described later.

Latch unit 72 latches the gain control amount received from control unit 71 and outputs it to D/A converter circuit 8 as a gain control value CNTL. Specifically, when latch unit 72 is receiving the gain control amount from control unit 71, latch unit 72 outputs received gain control amount to D/A converter circuit 8 as gain control value CNTL. On the other hand, when latch unit 72 is not receiving gain control amount from control unit 71, latch unit 72 outputs the gain control amount latched therein to D/A converter circuit 8 as gain control value CNTL.

Further, latch unit 72 takes in a gain control amount initial value INIT from initial value register 10 at a prescribed timing, and updates the gain control amount latched therein by thus taken in gain control amount initial value INIT. More specifically, in response to an instruction from control unit 71, latch unit 72 takes in gain control amount initial value INIT output from initial value register 10 at the end of a reception frame and latches. Then, latch unit 72 holds the value until the next reception frame starts, and at the start of the reception frame, outputs the value of gain control amount initial value INIT latched therein to D/A converter circuit 8 as gain control value CNTL.

D/A converter circuit 8 converts gain control value CNTL provided in digital value from latch unit 72 of gain control circuit 7 into an analog gain control voltage VG and outputs it to variable gain amplifier 4.

Gain control period generator circuit 9 receives a reception period signal RCV from controller 104, and generates gain control period signal GCEN that synchronizes to reception period signal RCV, and outputs it to control unit 71 of gain control circuit 7. Here, reception period signal RCV is a signal that attains H level during a reception frame, and gain control period signal GCEN is a signal instructing a gain control by control unit 71 of gain control circuit 7.

Initial value register 10 stores gain control amount initial value INIT. Here, gain control amount initial value INIT is an initial value of gain control amount at the start of a reception frame. Gain control amount initial value INIT output from initial value register 10 is taken in by latch unit 72 of gain control circuit 7 at the end of the reception frame. Alternatively, initial value register 10 may output gain control amount initial value INIT to latch unit 72 at the end of reception frame.

The value of gain control amount initial value INIT is set to initial value register 10 by controller 104 when the power supply of radio apparatus 100 shown in FIG. 1 is turned on. Specifically, when the power supply of radio apparatus 100 is turned on, controller 104 executes reset process for the entire radio apparatus 100. Then, controller 104 reads gain control amount initial value INIT stored in a non-volatile memory in memory 106, and downloads thus read gain control amount initial value INIT to initial value register 10 of reception apparatus 1.

Here, the timing where the value of gain control amount initial value INIT is set to initial value register 10 by controller 104 is not limited to the timing where the power supply of radio apparatus 100 is turned on, and it may be a reset time without turning the power supply on.

As above, the value of gain. control amount initial value INIT can be set from the outside of reception apparatus 1. In reception apparatus 1, the gain control amount, that is designed in advance in accordance with the propagation attenuating amount of a signal that is determined corresponding to the distance between reception apparatus 1 and the transmission apparatus that has sent the signal, is set as gain control amount initial value INIT.

It should be noted that reception period signal RCV is also supplied to RNA 2, mixer 3, variable gain amplifier 4, filter 5, and RSSI circuit 6, in addition to gain control period generator circuit 9. The power supply for each of the circuits is turned on to operate when reception period signal RCV is at H level, while it is turned off not to operate when reception period signal RCV is at L level.

Gain control period generator circuit 9, initial value register 10, and latch unit 72 constitute “a period generator circuit”, “a register”, and “a holding circuit”, respectively.

In order to reduce the power consumption, the power supply of reception apparatus 1 except for latch unit 72 and initial value register 10 is turned off, if it is not in a reception frame. Latch unit 72 is excepted since it needs to hold gain control amount initial value INIT that has been taken at the end of reception frame until next reception frame. Further, initial value register 10 is also excepted since it needs to hold the initial value set by controller 104.

At the start of reception frame, latch unit 72 of gain control circuit 7 outputs the value of gain control amount initial value INIT that has been taken in from initial value register 10 and latched at the end of previous reception frame as a gain control value CNTL. Variable gain amplifier 4 receives this value from latch unit 72 via D/A converter circuit 8, and amplifies a signal received from mixer 3 in accordance with this initial value. Thereafter, the gain of variable gain amplifier 4 is controlled by a feedback loop structured with RSSI circuit 6, gain control circuit 7, and D/A converter circuit 8, such that the signal level of reception signal RS is stabilized at a prescribed level.

Gain control period generator circuit 9 generates gain control period signal GCEN synchronizing to reception period signal RCV that attains H level during a reception frame. Specifically, during a reception frame, gain control period signal GCEN is at H level. Accordingly, in the first embodiment, gain control circuit 7 that operates receiving gain control period signal GCEN from gain control period generator circuit 9 controls the gain of variable gain amplifier 4 in accordance with the signal level of reception signal RS from the start of reception frame until the end thereof.

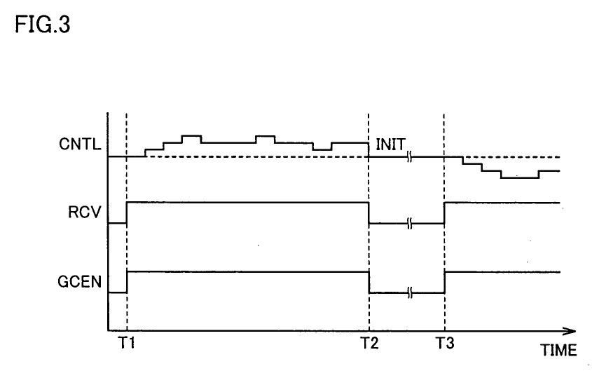

FIG. 3 is an operational waveform diagram of main signals in reception apparatus 1 according to the first embodiment.

Referring to FIG. 3, between time points T1 and T2 as well as after time point T3 are reception frames, and before time point T1 as well as between time points T2 and T3 are transmission frames. Before time point T1, gain control value CNTL is at the value of gain control amount initial value INIT held in latch unit 72, and both of reception period signal RCV and gain control period signal GCEN are at L level.

At time point T1, when a reception frame starts, reception period signal RCV attains H level. In response thereto, gain control period generator circuit 9 changes gain control period signal GCEN to H level. Further, latch unit 72 outputs gain control amount initial value INIT, which has been latched during a transmission frame, as an initial value of gain control value CNTL. Then, variable gain amplifier 4 amplifies the gain of reception signal in accordance with the value of gain control amount initial value INIT.

Between time points T1 and T2 that is a reception frame, reception period signal RCV is at H level, and gain control period generator circuit 9 changes gain control period signal GCEN to H level synchronizing to reception period signal RCV. Therefore, between time points T1 and T2, gain control circuit 7 outputs gain control value CNTL determined in accordance with signal level of reception signal RS to control the gain of variable gain amplifier 4.

At time point T2 where the reception frame ends, latch unit 72 takes in gain control amount initial value INIT received from initial value register 10, and updates the value latched therein with thus taken in gain control amount initial value INIT. Then, the power supply of each circuit except for latch unit 72 and initial value register 10 is turned off, and the latch unit 72 holds gain control amount initial value INIT until time point T3 where next reception frame starts.

At time point T3, where the reception frame starts again, latch unit 72 outputs holding gain control amount initial value INIT as the initial value of gain control value CNTL. The following operation is similar to that of after time point T1, therefore description thereof is not repeated.

In this first embodiment, since gain control period signal GCEN exactly synchronizes with reception period signal RCV, gain control period generator circuit 9 may not be provided, and gain control circuit 7 may directly receive reception period signal RCV to control the gain in accordance with that reception period signal RCV.

As above, according to reception apparatus 1 of the first embodiment, the initial value of gain control amount may be set externally, and initial value register 10 is provided that is capable of storing that initial value, which is used for the gain control of the reception signal in a reception frame. Thus, even when the environment changes in a period except for a reception frame, an improved gain controllability can be attained immediately after the start of the reception frame.

Second Embodiment

In a reception apparatus receiving a signal divided into time slots, it is important to stabilize the signal level of the reception signal immediately after the start of a reception frame. In other words, the gain controllability of AGC immediately after the start of a reception frame is particularly important. On the other hand, in a steady state, the fluctuation in the signal level of reception signal is small, and changes in gain control amount of variable gain amplifier is also small. Therefore, in a second embodiment, the gain control in accordance with the signal level of reception signal is only performed in a prescribed period after a reception frame starts. After that prescribed period expires, gain control is not performed and the gain control amount is fixed to the value at the expiration of the prescribed period.

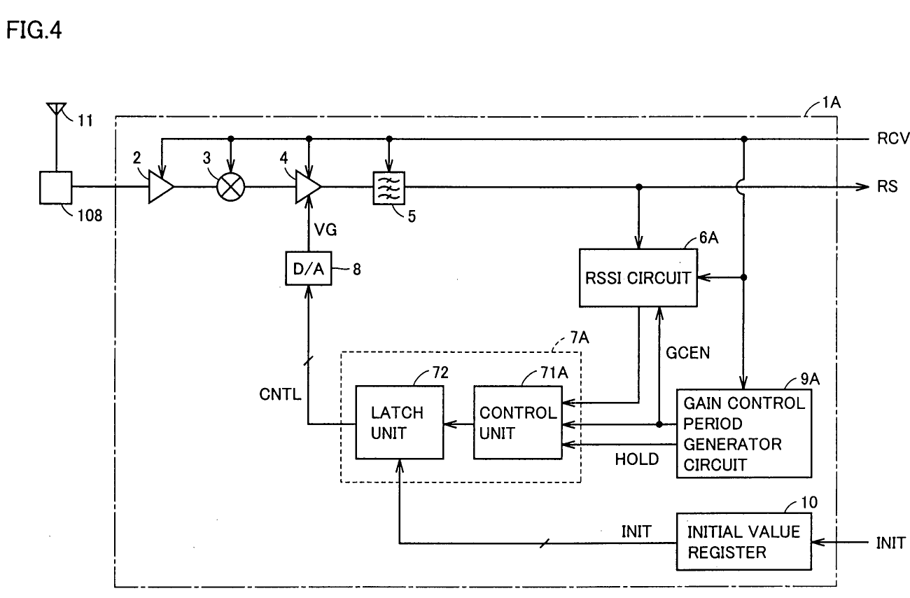

FIG. 4 is a functional block diagram functionally illustrating a reception apparatus according to the second embodiment of the present invention.

Referring to FIG. 4, a reception apparatus 1A includes, in the configuration of reception apparatus 1 according to the first embodiment, an RSSI circuit 6A, a gain control circuit 7A, and a gain control period generator circuit 9A, in place of RSSI circuit 6, gain control circuit 7, and gain control period generator circuit 9, respectively. Gain control circuit 7A includes, in the structure of gain control circuit 7, a control unit 7 1A in place of control unit 71.

Gain control period generator circuit 9A generates gain control period signal GCEN that is set to H level for a prescribed period from the reception timing of reception period signal RCV that is received from controller 104 (not shown) shown in FIG. 1, and outputs thus generated gain control period signal GCEN to gain control circuit 7A and RSSI circuit GA. Gain control period generator circuit 9A includes a timer therein, by which the prescribed period is measured.

Further, gain control period generator circuit 9A generates a gain holding period signal HOLD that is set to H level from the expiration of the prescribed period until reception period signal RCV is turned off, and outputs thus generated gain holding period signal HOLD to gain control circuit 7A. Here, gain holding period signal HOLD is a signal instructing gain control circuit 7A to output the value latched in latch unit 72 as gain control value CNTL, and not to perform gain control by control unit 71A of gain control circuit 7A.

Control unit 7 1A outputs gain control amount to latch circuit 72 that has been determined in accordance with a level detect signal received from RSSI circuit GA, when receiving gain control period signal GCEN at H level from gain control period generator circuit 9A. Further, control unit 71A does not output the gain control amount to latch unit 72 and stops its operation, when receiving gain control period signal GCEN at L level. Still further, control unit 7 1A instructs latch unit 72 to output the value latched therein, when receiving gain holding period signal HOLD at H level from gain control period generator circuit 9A.

RSSI circuit 6A outputs a level detect signal corresponding to the signal level of reception signal RS to gain control circuit 7A when gain control period signal GCEN received from gain control period generator circuit 9A is at H level. RSSI circuit 6A stops its operation when gain control period signal GCEN is at L level.

The rest of the circuit configuration in reception apparatus 1A is similar to that of reception apparatus 1, therefore description thereof is not repeated.

Similarly to reception apparatus 1 according to the first embodiment, the power supply of reception apparatus 1A except for latch unit 72 and initial value register 10 is turned off, when it is not in a reception frame. Then, at the start of a reception frame, latch unit 72 outputs the value of gain control amount initial value INIT that has been taken from initial value register 10 and latched at the end of previous reception frame as gain control value CNTL.

Thereafter, in reception apparatus 1A, gain of variable gain amplifier 4 is controlled by a feedback loop structured with RSSI circuit 6A, gain control circuit 7A and D/A converter circuit 8 only for a prescribed period where gain control period signal GCEN generated by gain control period generator circuit 9A attains H level, such that the signal level of reception signal RS is stabilized at a prescribed level.

When this prescribed period expires, gain control period generator circuit 9A changes gain control period signal GCEN to L level, and gain holding period signal HOLD to H level. Thus, RSSI circuit 6A and control unit 71A stop their operation, and the value of gain control value CNTL is fixed to the gain control amount at the time of expiration of the prescribed period, which is latched by latch unit 72.

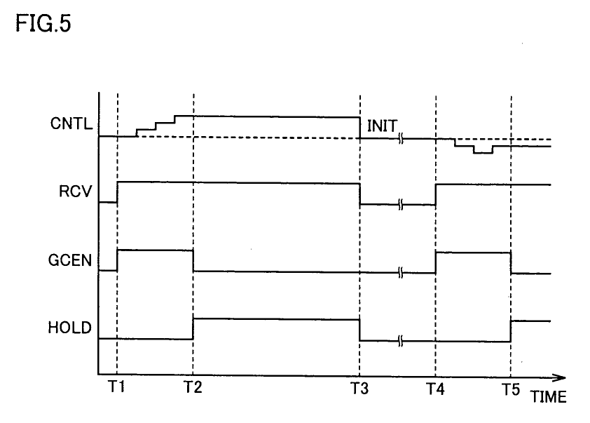

FIG. 5 is an operational waveform diagram of main signals in reception apparatus 1A according to the second embodiment.

Referring to FIG. 5, between time points T1 and T3 as well as after time point T4 are reception frames, and before time point T1 as well as between time points T3 and T4 are transmission frames. Before time point T1, gain control value CNTL is at the value of gain control amount initial value INIT held in latch unit 72, and reception period signal RCV, gain control period signal GCEN and gain holding period signal HOLD are all at L level.

At time point T1 when a reception frame starts, reception period signal RCV attains H level. In response thereto, gain control period generator circuit 9A changes gain control period signal GCEN to H level. Additionally, latch unit 72 outputs gain control amount initial value INIT, which has been latched during a transmission frame, as an initial value of gain control value CNTL. Then, variable gain amplifier 4 amplifies the gain of reception signal in accordance with the value of gain control amount initial value INIT.

Between time points T1 and T2 where gain control period signal GCEN is at H level, gain control circuit 7A outputs gain control value CNTL determined in accordance with the signal level of reception signal RS to control the gain of variable gain amplifier 4.

At time point T2 where the prescribed period elapses from time point T1, gain control period generator circuit 9A changes gain control period signal GCEN to L level, and gain holding period signal HOLD to H level. Therefore, after time point T2, RSSI circuit 6A and control unit 7 1A stop their operation, and gain control value CNTL is fixed to the value at the time point T2, which is latched by latch unit 72.

At time point T3 where the reception frame ends, latch unit 72 takes in gain control amount initial value INIT received from initial value register 10, and updates the value latched therein with thus taken in gain control amount initial value INIT. Then, power supply for each circuit except for latch unit 72 and initial value register 10 is turned off, and latch unit 72 holds gain control amount initial value INIT until the time point T4 where next reception frame starts.

At the time point T4 where the reception frame starts again, latch unit 72 outputs holding gain control amount initial value INIT as an initial value of gain control value CNTL. The following operation is similar to that of after time point T1, therefore description thereof is not repeated.

As above, according to reception apparatus 1A of the second embodiment, the gain control of reception signal in a reception frame is performed using the initial value stored in initial value register 10. Gain control is not performed after a prescribed period elapses where gain control is stabilized, and the value is fixed at that point. Further, the operation of RSSI circuit 6A and gain control circuit 7A is stopped. Thus, gain control amount of variable gain amplifier 4 is determined at an early stage, reducing the power consumption for controlling the gain.

Third Embodiment

In a third embodiment, the gain control of a variable gain amplifier is performed during the reception of header information of a reception signal, and the gain control amount after the reception of header information is fixed to the value at the time point where the header information reception is completed.

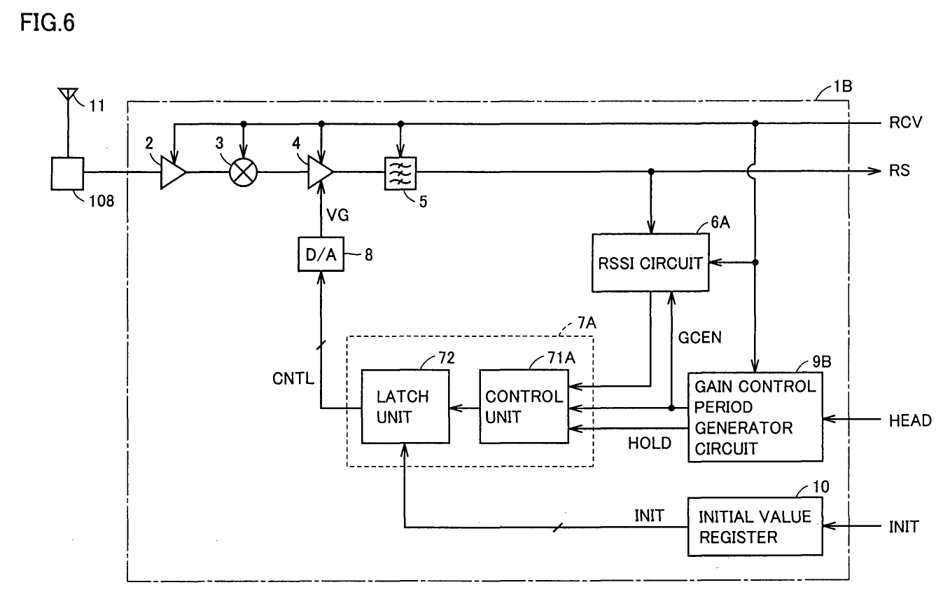

FIG. 6 is a functional block diagram functionally illustrating a reception apparatus according to the third embodiment of the present invention.

Referring to FIG. 6, a reception apparatus 1B includes, in the configuration of reception apparatus 1A according to the second embodiment, a gain control period generator circuit 9B in place of gain control period generator circuit 9A.

Gain control period generator circuit 9B receives reception period signal RCV and header detect signal HEAD from controller 104 (not shown) shown in FIG. 1. Then, gain control period generator circuit 9B changes gain control period signal GCEN to H level at the reception timing of reception period signal RCV, and also changes gain control period signal GCEN to L level at the reception timing of header detect signal HEAD that follows. Further, gain control period generator circuit 9B changes gain holding period signal HOLD to H level at the reception timing of header detect signal HEAD.

Here, header detect signal HEAD is a signal generated by controller 104 when the reception of header information included in the top of reception signal is completed. Gain control period generator circuit 9B holds gain holding period signal HOLD at H level until reception period signal RCV is off.

The rest of the circuit configuration in reception apparatus 1B is the similar to that of reception apparatus 1A, therefore description thereof is not repeated.

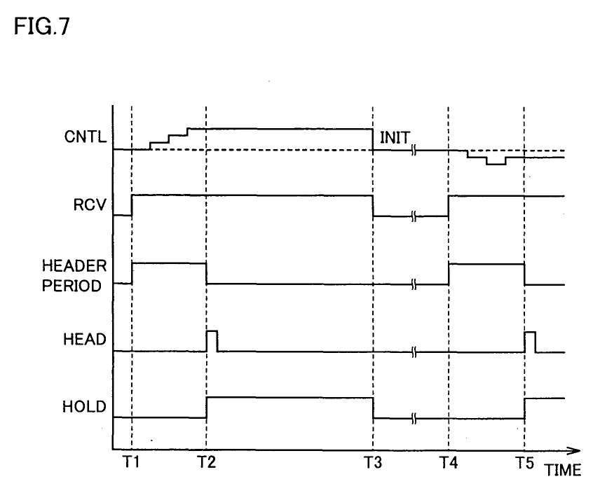

FIG. 7 is an operational waveform diagram of main signals in reception apparatus 1B according to the third embodiment.

Referring to FIG. 7, between time points T1 and T3 as well as after time point T4 are reception frames, and before time point T1 as well as between time points T3 and T4 are transmission frames. Before time point T1, gain control value CNTL is at the value of gain control amount initial value INIT held in latch unit 72, and reception period signal RCV, header detect signal HEAD and gain holding period signal HOLD are all at L level.

At time point T1, when a reception frame starts, reception period signal RCV attains H level. In response thereto, gain control period generator circuit 9B changes gain control period signal GCEN to H level (not shown). Further, latch unit 72 outputs gain control amount initial value INIT, which has been latched during a transmission frame, as an initial value of gain control value CNTL. Then, variable gain amplifier 4 amplifies the gain of reception signal in accordance with the value of gain control amount initial value INIT.

The period between time points T1 and T2 is a header period receiving header information in a reception signal, during which gain control circuit 7A outputs gain control value CNTL determined in accordance with the signal level of reception signal RS to control the gain of variable gain amplifier 4.

At time point T2 where header period expires, controller 104 generates header detect signal HEAD. Then, after receiving header detect signal HEAD from controller 104, gain control period generator circuit 9B changes gain control period signal GCEN to L level (not shown), and changes gain holding period signal HOLD to H level. Therefore, after time point T2, RSSI circuit 6A and control unit 71A stop their operation, and gain control value CNTL is fixed to the value at the time point T2, which is latched by latch unit 72.

At time point T3 where reception frame ends, latch unit 72 takes in gain control amount initial value INIT received from initial value register 10, and updates the value latched therein with thus taken in gain control amount initial value INIT. Then, power supply of each circuit except for latch unit 72 and initial value register 10 is turned off, and latch unit 72 holds gain control amount initial value INIT until time point T4 where next reception frame starts.

At time point T4 where the reception frame starts again, latch unit 72 outputs holding gain control amount initial value INIT as the initial value of gain control value CNTL. The following operation is similar to that of after time point T1, therefore description thereof is not repeated.

As above, according to reception apparatus 1B of the third embodiment, the gain control of a reception signal in a reception frame is performed using the initial value stored in initial value register 10. Further, the gain control is performed only during a period receiving header information of reception signal. Thus, similarly to the second embodiment, the gain control amount of variable gain amplifier 4 can be determined at an early stage, while reducing the power consumption for controlling the gain.

Further, since gain control period generator circuit 9B does not need to include a timer, the circuit area of reception apparatus 1B is reduced.

Fourth Embodiment

A reception apparatus according to a fourth embodiment includes two variable gain amplifiers, and corresponds to reception apparatus 1 according to the first embodiment with one variable gain amplifier.

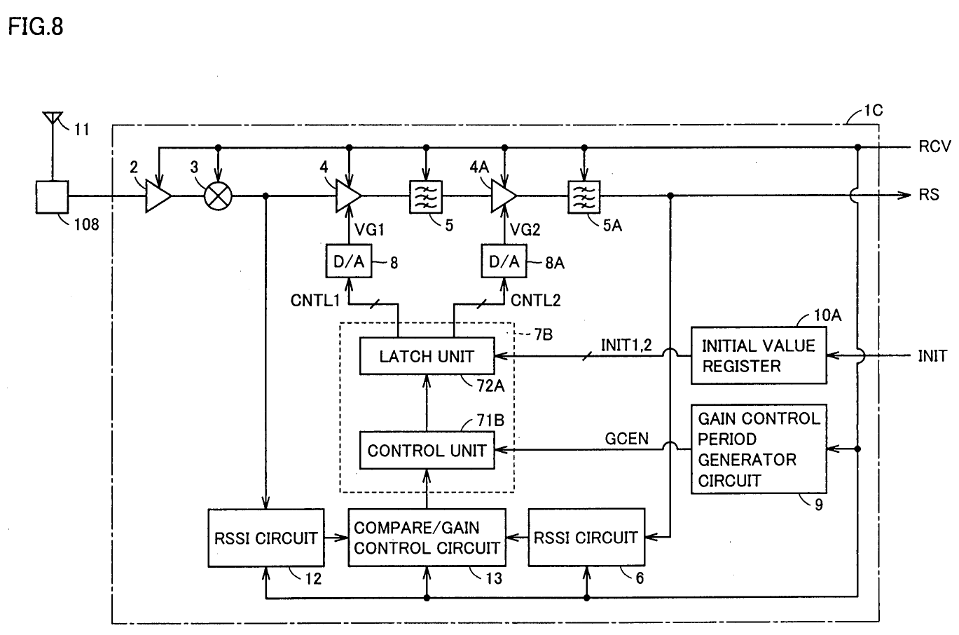

FIG. 8 is a functional block diagram functionally illustrating the reception apparatus according to the fourth embodiment of the present invention.

Referring to FIG. 8, a reception apparatus 1C includes, in the configuration of reception apparatus 1 according to the first embodiment, a variable gain amplifier 4A, a filter 5A, an RSSI circuit 12, a compare/gain control circuit 13, and a D/A converter circuit 8A additionally, and a gain control circuit 7B and an initial value register 10A in place of gain control circuit 7 and initial value register 10, respectively. Gain control circuit 7B includes a control unit 71B and a latch unit 72A.

Variable gain amplifier 4A amplifies the level of a signal received from filter 5 in accordance with a gain control voltage VG2 from D/A converter circuit 8A. Filter 5A removes an image signal from the signal amplified by variable gain amplifier 4A, and outputs reception signal RS to controller 104 (not shown) shown in FIG. 1 and RSSI circuit 6. RSSI circuit 12 detects the signal level of an input signal of variable gain amplifier 4, and outputs a level detect signal corresponding to that signal level to compare/gain control circuit 13.

Compare/gain control circuit 13 receives level detect signals from RSSI circuits 6 and 12, that correspond to reception signals before and after being subjected to the gain control, respectively. Then, compare/gain control circuit 13 compares the signal level between them, determines the gain control amount of variable gain amplifiers 4, 4A based on the comparison, and outputs thus determined gain control amount to gain control circuit 7B.

Control unit 71B of gain control circuit 7B receives gain control amounts of variable gain amplifiers 4, 4A from compare/gain control circuit 13, and outputs each gain control amount to latch unit 72A when gain control period signal GCEN received from gain control period generator circuit 9 is at H level. When gain control period signal GCEN is at L level, control unit 71B does not output each gain control amount to latch unit 72A.

Latch unit 72A latches gain control amounts received from control unit 71B and outputs to D/A converter circuits 8, 8A as gain control amounts CNTL1 and 2, respectively. Specifically, when latch unit 72A is receiving each of the gain control amounts from control unit 71B, it outputs each of the received gain control amounts to D/A converter circuits 8, 8A as gain control values CNTL1, 2, respectively. On the other hand, when latch unit 72A is not receiving each of the gain control amounts from control unit 71B, it outputs gain control amounts latched therein to D/A converter circuit 8, 8A as gain control value CNTL1, 2, respectively.

Further, latch unit 72A takes in gain control amount initial values INIT1, 2 from initial value register 10A at the end of a reception frame, and updates the gain control amounts of variable gain amplifiers 4, 4A latched therein with that gain control amount initial values INIT1, 2. Then, latch unit 72A holds those values until next reception frame starts, and at the start of reception frame, outputs the values of thus latched gain control amount initial values INIT 1, 2 to D/A converter circuits 8, 8A as gain control values CNTL1, 2, respectively.

D/A converter circuits 8A converts gain control value CNTL2 output from latch unit 72A of gain control circuit 7B in digital value into analog gain control voltage VG2, and outputs it to variable gain amplifier 4A.

Initial value register 10A stores gain control amount initial values INIT1, 2 corresponding to variable gain amplifiers 4, 4A, respectively. Then, gain control amount initial values INIT1, 2 output from initial value register 10A are taken in by latch unit 72A of gain control circuit 7B at the end of a reception frame. Alternatively, initial value register 10A may output gain control amount initial values INIT1, 2 to latch unit 72A at the end of the reception frame.

As in the first embodiment, the values of gain control amount initial values INIT1, 2 are set to initial value register 10A from controller 104 shown in FIG. 1 when the power supply of radio apparatus 100 shown in FIG. 1 is turned on, or when radio apparatus 100 is reset. Specifically, the values of gain control amount initial values INIT1, 2 can be set from the outside of reception apparatus 1C.

Reception period signal RCV is also supplied to variable gain amplifier 4A, filter 5A, RSSI circuit 12, and compare/gain control circuit 13. The power supply for these circuits is also turned on and the circuits operate when reception period signal RCV is at H level, while it is turned off and the circuits do not operate when reception period signal RCV is at L level.

The rest of the circuit configuration of reception apparatus 1C is similar to that of reception apparatus 1, therefore description thereof is not repeated.

Similarly to reception apparatus 1, the power supply of reception apparatus 1C except for latch unit 72A and initial value register 10A is also turned off in order to reduce the power consumption, when it is not in a reception frame. At the start of a reception frame, latch unit 72A outputs gain control amount initial values INIT1, 2 that has been taken in from initial value register 10A and latched at the end of previous reception frame as gain control values CNTL1, 2, respectively.

Variable gain amplifier 4 receives gain control value CNTL1 corresponding to gain control amount initial value INIT1 from latch unit 72A via D/A converter circuits 8, and amplifies a signal received from mixer 3 in accordance with this gain control amount initial value INIT1. Additionally, variable gain amplifier 4A receives gain control value CNTL2 corresponding to gain control amount initial value INIT2 from latch unit 72A via D/A converter circuit 8A, and amplifies a signal received from filter 5 in accordance with this received gain control amount initial value INIT2. Thereafter, the gain of variable gain amplifiers 4, 4A is controlled by gain control circuit 7B in accordance with a signal before subjected to the gain control and reception signal RS after subjected to the gain control, such that the signal level of reception signal RS is stabilized at a prescribed level.

As above, according to reception apparatus 1C of the fourth embodiment also, similar effect as the first embodiment can be attained.

Fifth Embodiment

A reception apparatus according to a fifth embodiment includes two variable gain amplifiers, and corresponds to reception apparatus 1A of the second embodiment with one variable gain amplifier.

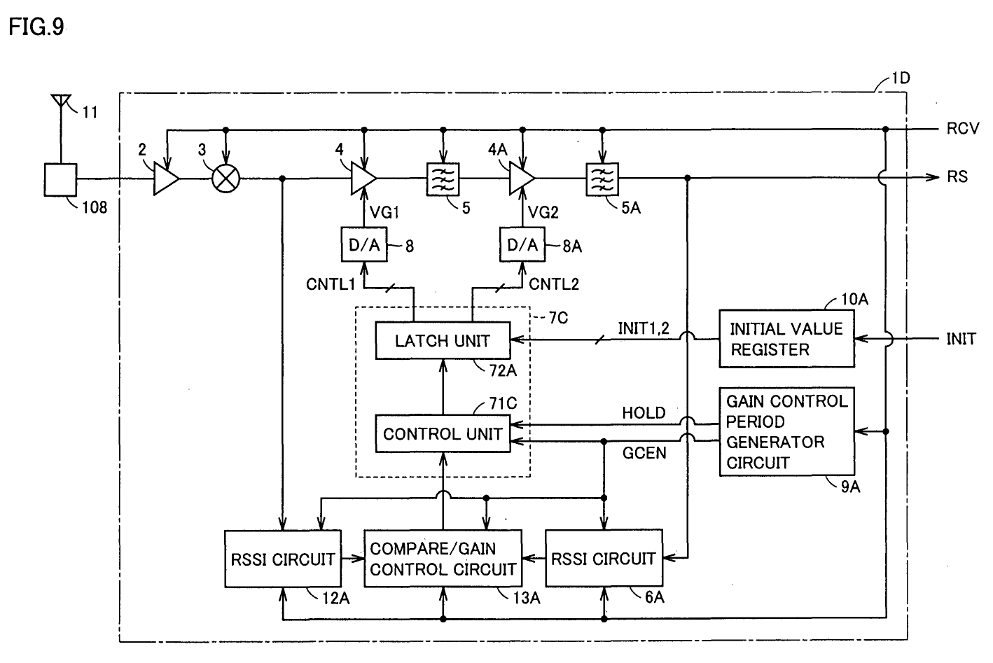

FIG. 9 is a functional block diagram functionally illustrating the reception apparatus according to the fifth embodiment of the present invention.

Referring to FIG. 9, a reception apparatus 1D includes, in the configuration of reception apparatus 1C of the fourth embodiment, RSSI circuits 6A, 12A, a compare/gain control circuit 13A, gain control circuit 7C, and gain control period generator circuit 9A, in place of RSSI circuits 6, 12, compare/gain control circuit 13, gain control circuit 7B, and gain control period generator circuit 9.

RSSI circuit 12A outputs a level detect signal corresponding to the signal level of an input signal to variable gain amplifier 4 to compare/gain control circuit 13A, when gain control period signal GCEN received from gain control period generator circuit 9A is at H level. When gain control period signal GCEN is at L level, RSSI circuit 12A stops its operation.

When compare/gain control circuit 13A is receiving gain control period signal GCEN at H level from gain control period generator circuit 9A, compare/gain control circuit 13A outputs gain control amounts of variable gain amplifiers 4, 4A determined corresponding to comparison result of detection level of level detect signals received from RSSI circuits 6A, 12A to control unit 71C. When receiving gain control period signal GCEN at L level, compare/gain control circuit 13A does not output gain control amounts to control unit 71C and stops its operation.

When control unit 71C is receiving gain control period signal GCEN at H level from gain control period generator circuit 9A, control unit 71C outputs each gain control amount received from compare/gain control circuit 13A to latch unit 72A. Further, control unit 71C does not output each gain control amount to latch unit 72A and stops its operation, when receiving gain control period signal GCEN at L level. Still further, control unit 71C instructs latch unit 72A to output the value latched therein, when receiving gain holding period signal HOLD at H level from gain control period generator circuit 9A.

The rest of the circuit configuration in reception apparatus1D has been described above, therefore description thereof is not repeated.

Similarly to reception apparatus 1C according to the fourth embodiment, the power supply of reception apparatus 1D except for latch unit 72A and initial value register 10A is also turned off when it is not in a reception frame, in order to reduce the power consumption. Then, at the start of a reception frame, latch unit 72A outputs gain control amount initial values INIT1, 2 that have been taken in from initial value register 10A and latched at the end of previous reception frame, as gain control values CNTL1, 2, respectively.

Thereafter, in this reception apparatus 1D, the gain of variable gain amplifiers 4, 4A is controlled by gain control circuit 7C in accordance with a signal before subjected to gain control and reception signal RS after subjected to gain control only for a prescribed period where gain control period signal GCEN generated by the control period generator circuit 9A attains H level, such that the signal level of reception signal RS will be stabilized at a prescribed level.

When this prescribed period expires, gain control period generator circuit 9A changes gain control period signal GCEN to L level, and gain holding period signal HOLD to H level. Thus, RSSI circuits 6A, 12A, compare/gain control circuit 13A, and control unit 71C stop their operation, and the values of gain control values CNTL1, 2 are fixed to the values at the expiration of this predetermined period, which are latched by latch unit 72A.

As above, reception apparatus 1D according to the fifth embodiment also attains the similar effect to the second embodiment of the present invention.

Sixth Embodiment

A reception apparatus according to a sixth embodiment includes two variable gain amplifiers, and corresponds to reception apparatus 1B according to the third embodiment with one variable gain amplifier.

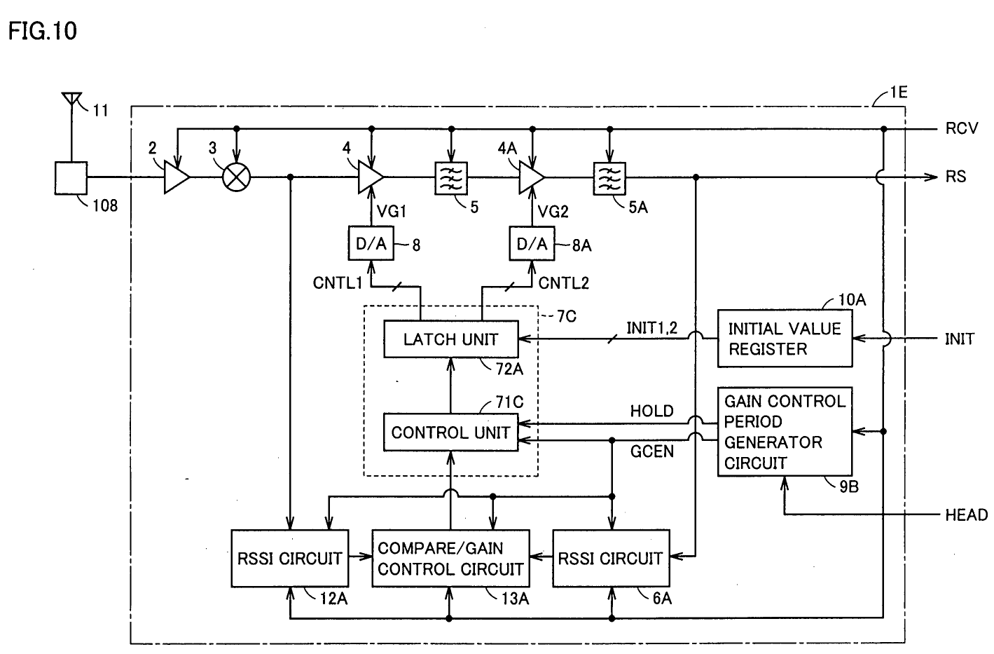

FIG. 10 is a functional block diagram functionally illustrating the reception apparatus according to the sixth embodiment of the present invention.

Referring to FIG. 10, a reception apparatus 1E includes, in the configuration of reception apparatus 1D according to the fifth embodiment, gain control period generator circuit 9B in place of gain control period generator circuit 9A. Gain control period generator circuit 9B is described in the third embodiment, therefore description thereof is not repeated. Further, since the rest of the circuit configuration of reception apparatus 1E is similar to that of reception apparatus 1D, description thereof is not repeated.

In reception apparatus 1E, the gain of variable gain amplifiers 4, 4A is controlled by gain control circuit 7C only during a header period in which header information is received, in accordance with a signal before subjected to the gain control and reception signal RS after subjected to the gain control, such that the signal level of reception signal RS is stabilized at a prescribed level.

When the header period expires, gain control period generator circuit 9B changes gain control period signal GCEN to L level, and gain holding period signal HOLD to H level. Thus, RSSI circuits 6A, 12A, compare/gain control circuit 13A and control unit 71C stop their operation, and gain control values CNTL1, 2 are fixed to the values at the expiration of header period, which are latched by latch unit 72A.

As above, reception apparatus 1E according to the sixth embodiment also attains the similar effect as the third embodiment.

Though radio apparatus 100 is structured with an integrated circuit on one semiconductor chip in the embodiments above, each of reception apparatus 1 (1A-1E), transmission apparatus 102, controller 104, memory 106, and transmission/reception divider 108 may be configured with separate semiconductor chips. Additionally, only part of radio apparatus 100, for example only memory 106 may be configured with a separate semiconductor chip.

Though RSSI circuit is employed as a circuit for detecting the level of reception signal RS in the embodiments above, a reception level detect circuit may be employed in place of RSSI circuit. While RSSI circuit successively detects changes in the signal level of reception signal RS, this reception level detect circuit detects if reception signal RS exceeds a predetermined level or not, which is not as accurate as RSSI circuit, but has an advantage of reducing power consumption.

Further, though gain control amount initial value INIT (INIT1, 2) stored in initial value register 10 (10A) is set by controller 104 external to the reception apparatus in the embodiments above, it may be a fixed value that is set in advance in the reception apparatus.

Still further, though gain control amount initial value INIT (INIT1, 2) stored in initial value register 10 (10A) is set by an external controller at power-on or reset of radio apparatus 100 in the embodiments above, a user of radio apparatus 100 may set any value at any timing. Thus, the initial value determined at the stage of designing can be modified in accordance with the actual usage situation.

Though the initial value of gain control amount is designed in accordance with the propagation attenuating value of a signal determined by the distance between the reception apparatus and the transmission apparatus that has sent the signal in the embodiments above, the determination method of this initial value is not limited thereto, and it may be designed considering the standards of the reception apparatus and various environments where the reception apparatus is used.

Still further, though variable gain amplifiers 4, 4A are controlled by a voltage in the embodiments above, they may be controlled by a current as well.

Still further, though variable gain amplifiers 4, 4A are provided as independent circuits in the embodiments above, variable gain amplifiers 4, 4A may be integrated in LNA 2, mixer 3 or filters 5, 5A. Still further, RSSI circuit or the reception level detect circuit that can be used as RSSI circuit may be provided in any position between LNA 2 and filters 5, 5A.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A reception apparatus receiving a time-division signal, comprising:
a variable gain amplifier circuit amplifying said signal received at an antenna to change a level of said signal to a prescribed level;
a gain control circuit outputting a gain control amount to said variable gain amplifier circuit to control a gain of said signal in said variable gain amplifier circuit; and
a register storing an initial value of said gain control amount set from outside, wherein
said gain control circuit starts to control said gain at each reception frame, using said initial value stored in said register.

2. The reception apparatus according to claim 1, wherein
said initial value is set to said register from said outside when a power supply of said reception apparatus is turned on or when said reception apparatus is reset.

3. The reception apparatus according to claim 1, further comprising
a signal level detect circuit detecting said level of said signal; wherein
said gain control circuit includes a holding circuit taking in said initial value from said register to hold, and
said gain control circuit starts to control said gain using said initial value that is held in said holding circuit, and subsequently, determines said gain control amount in accordance with said level of said signal that is detected by said signal level detect circuit, and outputs the determined gain control amount to said variable gain amplifier circuit at each reception frame.

4. The reception apparatus according to claim 3, wherein
said holding circuit takes in said initial value from said register at an end of said reception frame, and holds the taken in initial value until next reception frame.

5. The reception apparatus according to claim 3, wherein
said holding circuit further holds said gain control amount at an expiration of a prescribed period from a start of said reception frame,
said gain control circuit outputs, before the expiration of said prescribed period, said gain control amount that is determined in accordance with said level of said signal detected by said signal level detect circuit to said variable gain amplifier circuit, and
said gain control circuit outputs, after the expiration of said prescribed period, said gain control amount at the expiration of said prescribed period that is held by said holding circuit to said variable gain amplifier circuit.

6. The reception apparatus according to claim 5, further comprising
a period generator circuit generating said prescribed period; wherein
said period generator circuit notifies said gain control circuit of said prescribed period.

7. The reception apparatus according to claim 6, wherein
said period generator circuit includes a timer for measuring said prescribed period.

8. The reception apparatus according to claim 5, wherein
said time-division signal includes header information, and
said prescribed period is a period for receiving said header information.

9. The reception apparatus according to claim 1, further comprising:
a first signal level detect circuit detecting a level of the signal that is amplified by said variable gain amplifier circuit; and
a second signal level detect circuit detecting a level of the signal before input to said variable gain amplifier circuit; wherein
said gain control circuit compares first and second signal levels detected by said first and second signal level detect circuits, respectively, determines said gain control amount based on a result of the comparison, and outputs said determined gain control amount to said variable gain amplifier circuit.

10. The reception apparatus according to claim 1, wherein
said initial value is determined in accordance with an attenuation amount of said signal propagating from a transmission apparatus transmitting said signal to said reception apparatus.
